(19) United States
(12) Patent Application Publication
(10) Pub. No.: US 2018/0067327 A1
(43) Pub. Date: Mar. 8, 2018

(54) MULTI-WAVELENGTH BEAM SPLITTING SYSTEMS FOR SIMULTANEOUS IMAGING OF A DISTANT OBJECT IN TWO OR MORE SPECTRAL CHANNELS USING A SINGLE CAMERA

(71) Applicant: East Carolina University, Greenville, NC (US)

(72) Inventors: Zhiyong Peng, Greenville, NC (US); T. Bruce Ferguson, JR., Raleigh, NC (US); Cheng Chen, Greenville, NC (US); Kenneth Michael Jacobs, Greenville, NC (US)

(21) Appl. No.: 15/559,605

(22) PCT Filed: Mar. 22, 2016
(86) PCT No.: PCT/US2016/023547

§ 371 Date: Sep. 19, 2017

Related U.S. Application Data
(60) Provisional application No. 62/136,815, filed on Mar. 23, 2015.

(51) Int. Cl. G02B 27/10; G02B 27/14; G03B 33/12; H04N 9/09; G02B 27/00

(52) U.S. Cl. CPC G02B 27/1013; G02B 27/141; G02B 27/0025; H04N 9/09; G03B 33/12

(57) ABSTRACT

An optical imaging system and related methods are provided that acquire images of an object at a distance in different spectral regions using only one camera. The systems and methods are adaptable to applications where information (simultaneous or sequential) from more than one spectral region is of interest while only one camera is available or entailed.

### CLAIM OF PRIORITY

The present application claims priority to U.S. Provisional Application No. 62/136,815, filed Mar. 23, 2015, entitled Multi-Wavelength Beam Splitting System for Simultaneous Imaging of A Distant Object In Two Or More Spectral Channels Using a Single Camera, the disclosure of which is hereby incorporated herein by reference as if set forth in its entirety.

### RESERVATION OF COPYRIGHT

A portion of the disclosure of this patent document contains material which is subject to copyright protection. The copyright owner, East Carolina University of Greenville, N.C., has no objection to the reproduction by anyone of the patent document or the patent disclosure, as it appears in the Patent and Trademark Office patent file or records, but otherwise reserves all copyright rights whatsoever.

### FIELD

The present inventive concept relates generally to imaging and, more particular, to imaging objects at a distance using various imaging technologies.

### BACKGROUND

In certain optical imaging applications, images arising from the same sample need to be registered in different wavelength regions according to their spectral characteristics. For example, this may occur in fluorescent imaging applications and reflectance imaging applications.

Typically, in these multiple wavelength circumstances, more than one camera and/or lens array is used, each camera/lens array being configured for a discrete spectral wavelength region, i.e. wavelength range. However, the use of two cameras/lens arrays may have a number of inherent disadvantages. For example, when multiple camera lenses are used for imaging with a single camera, the sample (region of interest) may not be viewed from the same angle through each lens. Therefore, the spatial information obtained through one lens does not duplicate that from the other lens, and there is no pixel-to-pixel spatial correlation between these two images. Furthermore, with multiple lens systems, since the images through different camera lenses do not overlap synchronously, software correction may be needed to find a common field of view. Software correction generally slows down image processing and display of the resulting images.

Similarly, when multiple cameras are used in the optical design, the above angle and angle correction problems remain. In addition, the cameras may have to be synchronized for data collection and to perform image analysis from different spectral channels pixel by pixel. This synchronization typically requires sophisticated triggering mechanisms for data capture, which are technologically challenging and add cost to the system design.

### SUMMARY

Some embodiments of the present inventive concept provide multi-wavelength beam splitting optical systems including a single camera having a single imaging lens. The single camera is configured to capture two or more images in two or more spectral channels from the same field of view using the single camera.

In further embodiments, the system may be configured for both microscopic and far-field imaging.

In still further embodiments, the system may be configured for far-field imaging with a field of view of no less than 1 cm×1 cm.

In some embodiments, the two or more images taken by the single camera may be exact duplicates. In certain embodiments, the two or more images may contain a same spatial resolution from the sample and may be identical pixel to pixel.

In further embodiments, the system may perform without the need for image alignment and/or registration during image acquisition or post-image acquisition.

In still further embodiments, the system may further include a lens system including a plurality of integrated convex lenses, dichroic mirrors, 45 degree reflectors, and interference filters allowing a reduction in divergence of the off-axis rays such that resulting images are not blurred.

In some embodiments, the system may have a fixed working distance and an adjustable field of view.

In further embodiments, the field of view of the system may be adjusted by integrating different square apertures and/or different convex lenses into the system.

In some embodiments, the system may further include a square aperture. A z-axis position and orientation of the square aperture may be adjusted using an opti-mechanical mounting unit.

In still further embodiments, the opti-mechanical mounting unit may include a U-shaped three element lens mount assembly configured to facilitate alignment of the beam splitting system.

In some embodiments, the system may be configured for real-time imaging and may not require alignment during an imaging procedure.

In further embodiments, the two or more spectral channels may include reflectance imaging, Laser Speckle Imaging, Laser Doppler Imaging, Near-Infrared Fluorescence Imaging, and any combination thereof.

In still further embodiments, the single camera may perform simultaneous multiple image capturing to improve camera synchronization and/or triggering.

Some embodiments of the present inventive concept provide a camera for use in a multi-wavelength beam splitting optical system, the camera including a single imaging lens. The camera may be configured to capture two or more images in two or more spectral channels from the same field of view using the camera.

Further embodiments of the present inventive concept provide methods for operating a multi-wavelength beam splitting optical system including capturing two or more images in two or more spectral channels from a same field of view using a single camera having a single imaging lens.

### BRIEF DESCRIPTION OF THE DRAWINGS

FIG. 1 is a diagram of a system for imaging using a single camera in accordance with some embodiments of the present inventive concept.

FIG. 2 is a more detailed diagram of an imaging system having a dual-wavelength optical beam splitter for simultaneous image capturing with a single digital camera in accordance with some embodiments of the present inventive concept.

FIG. 3 is a diagram illustrating an opti-mechanical mounting holder for a camera lens and square aperture assembly in accordance with some embodiments of the present inventive concept.

FIGS. 4A and 4B are two equivalent images of a test sample captured by the beam splitter and charge-coupled device (CCD) camera of FIG. 2.

### DETAILED DESCRIPTION

Embodiments of the present inventive concept will now be described more fully hereinafter with reference to the accompanying figures, in which preferred embodiments of the inventive concept are shown. This inventive concept may, however, be embodied in many different fol. ms and should not be construed as limited to the embodiments set forth herein. Like numbers refer to like elements throughout. In the figures, layers, regions, elements or components may be exaggerated for clarity.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the inventive concept. The sequence of operations (or steps) is not limited to the order presented in the claims or figures unless specifically indicated otherwise.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

As discussed above, conventional methods and systems for imaging a sample using two or more wavelengths generally use multiple cameras and/or lens arrays, which can add complexity and cost to the imaging process. Accordingly, some embodiments of the present inventive concept provide an optical imaging system and related methods that acquire images of an object at a distance in different spectral regions using only one camera. Embodiments of the present inventive concept are adaptable to applications where information (simultaneous or sequential) from more than one spectral region is of interest while only one camera is available or entailed. Thus, embodiments of the inventive concept may not experience the issues related to, for example, angle correction, data acquisition synchronization and the like experienced by the two camera/lens array systems.

As will be discussed further below with respect to the figures, some embodiments of the present inventive concept use a single camera lens to capture images from a sample at a distance. The single lens is coupled with a single camera. The spectral information of the same imaged sample is projected onto adjacent regions in the same camera sensor, separated/split into two or more different spectral channels, which includes two or more optical paths and a number of optical elements as will be discussed further herein.

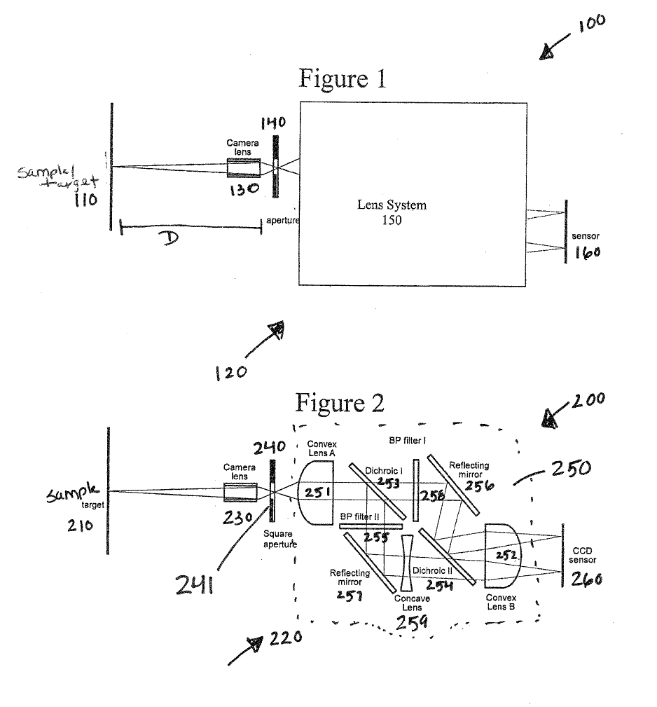

Referring now to FIG. 1, an imaging system including a single camera in accordance with some embodiments of the present inventive concept will be discussed. As illustrated in FIG. 1, the system 100 includes a target/sample 110, a camera 120 including a camera lens 130, an aperture 140, a lens system 150 and sensor 160. The camera 120 can be any digital camera equipped with a rectangular sensing area (aperture) 140. In some embodiment the aperture 140 has a length-to-width ratio of 1:1, so that the substantially similar, ideally identical, images from the two color channels can be projected side by side onto the same camera sensor 160, for example, a charge-coupled device (CCD) sensor. FIG. 1 is a high level block diagram of a system in accordance with embodiments discussed herein. The lens system 150 enables a multiple wavelength system using a single camera sensor, which reduces the problems discussed above that occur in two cameras or multiple lens array systems. Details of the lens system 150 will be discussed below with respect to FIG. 2.

Referring now to FIG. 2, a more detailed block diagram illustrating some embodiments of a beam splitting system for dual-wavelength imaging using a single camera sensor in accordance with some embodiments of the present inventive concept will be discussed. As illustrated in FIG. 2, the system 200 includes a target/sample 210, a camera 220 including a camera lens 230, an aperture 240 and sensor 260. The system 200 illustrated in FIG. 2 further illustrates the details of the lens system 150 of FIG. 1. The lens system includes first and second convex lenses 251 and 252, respectively, first and second dichroic filters 253 and 254, respectively, first and second reflecting mirrors 255 and 256, respectively, a concave lens 259 and first and second bandpass (BP) filters 255 and 258, respectively. Details of the operations of the lens system 250 will be discussed further below.

The camera 220 includes a camera lens 230, which may be a commercial camera lens with a fixed focal length of, for example, 8.5 mm. The camera lens 230 is used as the primary imaging element to collect light from a sample at a distance D of about 30 cm. The incoming light arising from the sample is focused to a virtual image plane 241 located right at the position of aperture 240. The focused light from the first image plane 240 is relayed to a first convex optical lens 251 having a focal length of, for example, 30 mm. In some embodiments, the first convex optical lens 251 is positioned down the optical path at a distance of exactly 30 mm from the first image plane 241, so that the light exiting from the first image plane becomes collimated when transmitted through the first convex optical lens 251. The collimated light is passed through a first dichroic filter 253, where the light rays in different spectral ranges are initially separated into different color channels as illustrated in FIG. 2. The first dichroic filter 253 is positioned at an angle of 45 degrees with respect to the optical path, so that photons at a wavelength longer than a cut-off wavelength of the dichroic travel along the direct path of the incoming beam, and photons at a wavelength shorter than the cut-off wavelength of the dichroic are bent into a direction perpendicular to the original direction of incoming light.

The light beam having a longer wavelength is bent towards the second dichroic filter 254, which serves as a combiner of light beams in different spectral regions. The second dichroic filter 254 has opposite spectral characteristics to the first dichroic filter 253. Thus, it allows light having a shorter wavelength than its cut-off band to transmit, and reflects light having a longer wavelength. Therefore, the light beam having the longer wavelength is redirected to the camera sensor 260. The light beam having a shorter wavelength, bent by the first dichroic filter 253, is redirected by a reflection mirror 257, placed at an angle of roughly 45 degrees with respect to an incoming light path, towards the second dichroic filter 254. A custom made concave lens 259 is placed between 257 and 254 to adjust the light beam for chromatic aberrations corrections. This light beam is transmitted through the second dichroic filter 254 and projected onto the camera sensor 260. A second convex lens 252 having a fixed focal length of, for example, 60 cm, is placed after the second dichroic filter 254 in the light path to re-focus the incoming light at different wavelengths to the camera sensor 260. A first bandpass filter 258 is placed in the light path of the longer wavelength beam, and a second bandpass filter 255 is placed in the light path of the shorter wavelength beam to allow light within the spectral interest to pass, and block other light noise.

It will be understood that in some embodiment of the present inventive concept, the beam splitting system can be adapted to any optical imaging setup including, for example, wide-field imaging as well as microscopic imaging with careful selection of appropriate optical elements. Furthermore, embodiments of the present inventive concept are not restricted to optical imaging in only two wavelength channels. For example, embodiments of the present inventive concept can be extended to any number of wavelength channels by incorporating additional dichroic filters, reflectors, and appropriate chromatic correction lenses in the setup without departing from the scope of the present inventive concept.

In some embodiments, the position and angle of the mirrors, filters, dichroic filters and lens can be adjusted to achieve better alignment of the two fields of view and quality of image to accommodate different optical characteristics of different wavelengths.

In some embodiments, the sample may have an optimal object distance of 30 cm. In these embodiments, the sample can move within 30 cm±5 cm without noticeably worsening the image quality to accommodate a larger (move target further away from the camera lens; object distance >30 cm) or smaller target (move the target closer to the camera lens; object distance <30 cm).

It will be understood that embodiments of the present inventive concept are not limited to the configuration of the lens system 250 as illustrated in FIG. 2. Other configurations may be used to facilitate embodiments of the present inventive concept without departing from the scope discussed herein.

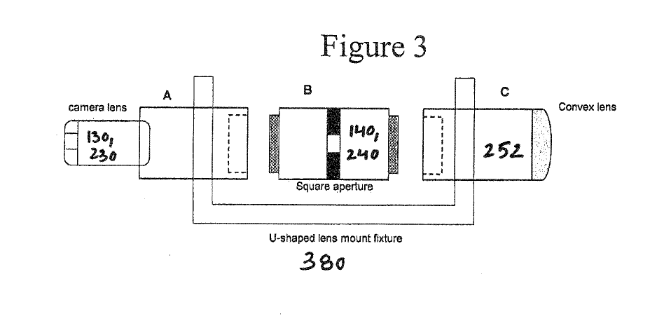

Referring now to FIG. 3, alignment of the dual-wavelength beam splitter in accordance with some embodiments of the present inventive concept will be discussed. As illustrated in FIG. 3, camera systems in accordance with some embodiments may include a camera lens mount fixture 380 which facilitates mounting of the camera lens 130, 230, the square aperture 140, 240 and the focusing lens (convex lens 252). As illustrated, the camera lens mount 380 includes a camera lens mount (A), an aperture mount (B) and a focusing lens mount (C). In some embodiments, the lens mount 380 (opti-mechanical mounting unit) may have a U shape as illustrated in FIG. 3, however, it will be understood that embodiments of the present inventive concept are not limited to this configuration.

In order to generate two identical images of an object at a distance in this optical system, the optical elements need to be aligned to the right positions. In the alignment strategy, the square aperture 140, 240 needs to be aligned at first. The second convex lens 252 with an effective focal length (EFL) of 60 mm is positioned such that the camera sensor 260 is right at its focal length by pointing the camera to a distant object of greater than 10 m away to form a clear and sharp image. Then the square aperture 140, 240 is moved along the optical axis to form a sharp image onto the camera sensor 260 when it is located exactly at the focal point of the first convex lens which, for example, may be an EFL of 30 mm.

As illustrated in FIG. 3, the camera lens 130, 230 is mounted on “A” and moved along the optical axis until a sharp image of a test sample about 30 cm away is formed onto the camera sensor 260. Camera lens mount “A”, and convex lens mount “C”, are fixed on a U-shaped holder, and the aperture mount is connected to “A” and “C”, and can be shifted freely along the optical axis to find its exact position without having to turn the whole mounting assembly.

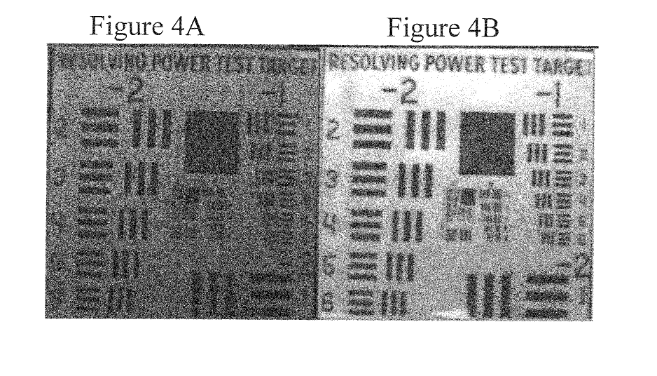

Referring now to FIGS. 4A and 4B, two equivalent images of a test sample captured by the beam splitter and camera of FIG. 3 will be discussed. In embodiments of the present inventive concept illustrated in FIGS. 4A and 4B, each figure alone (4A and 4B) has a field of view (FOV) of 8 cm×8 cm, with an object distance of 30 cm. In operation, a single image is first generated and projected to the center of the camera sensor 260 by tuning the knobs for both reflecting mirrors 256 and 257. The orientation of the first reflecting mirror 256 is carefully tuned so that the image from the longer wavelength channel is precisely projected onto the left half of the camera sensor 260. The orientation of the second reflecting mirror 257 is then carefully tuned so that the image from the shorter wavelength channel is precisely projected onto the right half of the camera sensor 260. These two images can be furthered positioned to pixel level using an alignment algorithm in accordance with some embodiments of the present inventive concept. As illustrated in FIGS. 4A and 4B, the final two images are an exact copy of each other spatially, and can be analyzed pixel-by-pixel.

As discussed briefly above, some embodiments of the present inventive concept provide a beam splitting system including an imaging lens assembly with a single optical axis, a dichroic mirror to separate the incoming light into different spectral channels, a number of angled reflection surfaces, and a number of interference filters, which are enclosed in an optical cage to shield ambient light. A unique square optical aperture is placed between the imaging lens and the first convex lens to define the desired field of view projected onto the imaging sensor.

Embodiments of the present inventive concept discussed herein allow the optical beam splitter as defined to be used in conjunction with a standard digital camera with a rectangular sensing area and a single imaging lens (including microscope objective). In some embodiments, the imaging lens has a tunable iris to adjust the amount of light that can reach the camera which determines the brightness of the captured images.

Engineered differently from a commercially available beam splitter, beam splitting devices as discussed herein can be used in conjunction with a microscope objective for close field imaging, and also with a common camera lens for wide field imaging. Conventional beam splitters are designed for microscopic applications where a microscope objective is used to collect incoming light rays from the target to be interrogated, and the field of view is no more than a few millimeters. The sample is placed at the focal plane of the microscope objective, making the objective distance less than a millimeter away; the light rays after the microscope objective are nearly parallel to the optical axis (on-axis rays). Thus, in conventional beam splitters, the total path length of the light rays is not taken into account and optical elements can be loosely placed.

If the conventional beam splitting design is applied with a common camera lens for far-field imaging, a big portion of the incoming light rays is not parallel to the optical axis (off-axis rays) anymore and the resulting images are susceptible to blurring caused by off-axis rays. Accordingly, as discussed above, embodiments of the present inventive concept provide a beam splitting design for simultaneous multi-wavelength imaging substantially different than conventional systems. In some embodiments of the present inventive concept, the overall light path length is of primary concern in the design, and the convex lenses, dichroic mirrors, reflectors, and emission filters are all carefully designed and optimized in a gapless fashion to reduce, or possibly, minimize, the total path length of the off-axis rays along their propagation. The off-axis light rays are refocused by the second convex lens to the camera before they diverge to the peripheral regions of the optical lens so that a clear image can be formed on the two adjacent regions of the camera sensor. Furthermore, a secondary dichroic minor rather than another reflector is used to combine light from both wavelengths and further reduce or, possibly minimize, the overall path length of the off-axis rays and improve the image clarity.

The sensing area of the camera needs to be sensitive across the two or more spectral regions where the wavelength-dependent optical features of the target are to be interrogated. The sensor meets the geometrical ratio of n:1, where n is the number of spectral wavelengths to be acquired, in order that the n equivalent images of the same target can be captured with the maximum field of view.

In the drawings and specification, there have been disclosed example embodiments of the inventive concept. Although specific terms are employed, they are used in a generic and descriptive sense only and not for purposes of limitation, the scope of the inventive concept being defined by the following claims.

That which is claimed is:

1. A multi-wavelength beam splitting optical system comprising:
a single camera having a single imaging lens, the single camera configured to capture two or more images in two or more spectral channels from a same field of view using the single camera sensor.

2. The system of claim 1, wherein the system is configured for both close-field and far-field imaging.

3. The system of claim 1, wherein the system is configured for far-field imaging with a field of view of no less than 1 cm×1 cm.

4. The system of claim 1, wherein the two or more images taken by the single camera are exact duplicates.

5. The system of claim 4, wherein the two or more images contain a same spatial resolution from the sample and are identical pixel to pixel.

6. The system of claim 1, wherein the system performs is without the need for image alignment and/or registration during image acquisition or post-image acquisition.

7. The system of claim 1, wherein the system further comprises a lens system including a plurality of integrated convex lenses, dichroic mirrors, 45 degree reflectors, and interference filters allowing a reduction in divergence of the off-axis rays such that resulting images are not blurred.

8. The system of claim 7, wherein the system has a fixed working distance and an adjustable field of view.

9. The system of claim 1, wherein the field of view of the system is adjusted by integrating different square apertures and/or different convex lenses into the system.

10. The system of claim 1, further comprising a square aperture, wherein a z-axis position, and orientation of the square aperture is adjusted using an opti-mechanical mounting unit.

11. The system of claim 10, wherein the opti-mechanical mounting unit comprises a U-shaped three element lens mount assembly configured to facilitate alignment of the beam splitting system by reducing the adjustment steps.

12. The system of claim 1, wherein the system is configured for real-time imaging and does not require alignment during an imaging procedure.

13. The system of claim 1, wherein the two or more spectral channels comprise reflectance imaging, Laser Speckle Imaging, Laser Doppler Imaging, Near-Infrared Fluorescence Imaging, and any combination thereof.

14. The system of claim 1, wherein the single camera performs simultaneous multiple image capturing to reduce the likelihood of camera synchronization and/or triggering.

15. A camera for use in a multi-wavelength beam splitting optical system, the camera comprising:
a single imaging lens, the camera being configured to capture two or more images in two or more spectral channels from a same field of view using the camera.

16. The camera of claim 15, wherein the two or more images taken by the camera are exact duplicates.

17. The camera of claim 16, wherein the two or more images contain a same spatial resolution from the sample and are identical pixel to pixel.

18. The camera of claim 15, wherein the two or more spectral channels comprise reflectance imaging, Laser Speckle Imaging, Laser Doppler Imaging, Near-Infrared Fluorescence Imaging, and any combination thereof.

19. The camera of claim 15, further configured to perform simultaneous multiple image capturing to reduce the likelihood of camera synchronization and/or triggering.

20. A method for operating a multi-wavelength beam splitting optical system, the method comprising capturing two or more images in two or more spectral channels from a same field of view using a single camera having a single imaging lens.
